(19) United States
(12) Patent Application Publication
(10) Pub. No.: US 2009/0183248 A1
(43) Pub. Date: Jul. 16, 2009

(54) TWO-WAY ERROR CORRECTION FOR PHYSICAL TOKENS

(75) Inventors: Pim Theo Tuyls, Eindhoven (NL); Boris Skoric, Eindhoven (NL); Marten Erik Van Dijk, Cambridge, MA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,278

(22) PCT Filed: Oct. 4, 2005
(86) PCT No.: PCT/IB05/53255

§ 371 Date: Mar. 29, 2007

(30) Foreign Application Priority Data
Oct. 4, 2004 (EP) 04104842.2

(51) Int. Cl. H04L 9/32; G06F 21/00

(52) U.S. Cl. 726/9; 713/172

(57) ABSTRACT

The invention relates to a method of establishing a shared secret between two or more parties, based on a physical token, wherein helper data from both the enrolment and the authentication measurement is used in such a way that only response data reliable at both measurements is used to generate the shared secret. The generated shared secret is therefore identical to both parties to a high degree of certainty. The invention further relates to a system for generating such a shared secret, comprising a central database server and a terminal, or any one of them.

The invention relates to a method of establishing a shared secret between two or more parties, based on a physical token, in particular a Physical Uncloneable Function (PUF), for the purpose of identification, authorization, and cryptography in secure transactions. The invention further relates to a system for generating such a shared secret, comprising a proving apparatus and a verifying apparatus. The invention also relates to the proving apparatus and the verifying apparatus.

The use of physical tokens for the purpose of identification, authentication and generation of encryption/decryption keys is known in the art. A token can be embedded in e.g. a smart card and used in secure transactions. Before issuing such a card to a user, the token is enrolled in what is called the “enrolment phase”, in which it is subjected to one or more challenges. The challenges and the corresponding responses are stored together with information identifying the token, possibly along with other data, so as to form the “enrolment data”. When the smart card is used by the user, in what is called the “authentication phase”, the identity of the token is verified by challenging the token with one or more of the stored challenges corresponding to the information identifying the token. If the response or responses obtained are the same as the response or responses stored in the enrolment data, the identification is successful. In some protocols, this challenge-response procedure also results in a shared secret that is derived from the responses by means of some processing operation which converts the physical output of a token to a bit string. The shared secret can then be used as a session key for secure transactions between two parties.

There are many examples of physical tokens: planar fiber distributions (as e.g. referenced in the proceedings of the IEEE ISIT Conference 2004, p. 173), all biometrics and in particular Physical Uncloneable Functions (PUFs). A “physical token” is understood to be, in general, a physical object that is probed by means other than memory access, and the response depends on the physical structure of the object. The direct, unprocessed response of the physical token may be either analog or digital. The response can be processed to obtain a digital bit string. In contrast, a digital token consists of a digital memory having stored a response for a given set of challenges, e.g. a bit string that has been written into it at every address.

PUFs are also known as Physical Random Functions or Physical One-Way Functions. US Patent 2003/0,204,743 describes the use of devices with unique measurable characteristics together with a measurement module for authentication purposes. Another method of authentication based on 3D structures, probing, and comparison is described in U.S. Pat. No. 6,584,214. In general, PUFs are physical tokens that are extremely hard to clone, where “cloning” may be either (i) producing a physical copy, or (ii) creating a computer model that mimics the behavior. PUFs are complex physical systems comprising many randomly distributed components. When probed with suitable challenges, the complex physics governing the interaction between the PUF and the challenge, e.g. multiple scattering of waves in a disordered medium, lead to a random-looking output, or response, for each individual challenge. The complex small-scale structure of the PUF makes it hard to produce a physical copy, while the complexity of the physical interactions defies computer modeling. For example, an optical PUF may comprise an optical medium containing many randomly distributed scatterers. A challenge may be an incident beam, and the response is then the consequent speckle pattern detected on a detector. The pattern of bright and dark spots can be converted to a bit string.

The problem with all physical tokens, in contrast to digital tokens, is that the responses are susceptible to noise. The measurement noise can have many causes, e.g. token/detector misalignment, or environmental effects like temperature, moisture and vibrations. Due to the noise, the bit string that is extracted from a response may have errors. Most cryptographic protocols require the bit string obtained during the authentication phase to be exactly equal to the one obtained during the enrolment phase. For example, if the bit string is used as an encryption key, one bit flip in the key will yield an unrecognizable, useless result.

Two methods known in the art can be used to at least partially remedy the problems described above.

One method is the use of error-correcting codes, capable of detecting and correcting a number of bit errors equal to a certain percentage of the total bit string length. However, the use of such a code puts a burden on the process of bit string extraction, and grows with the number of errors that can be corrected.

Another method is the use of response reliability information, also known in the art as “helper data” or side information. In general, response reliability information consists of extra information, stored together with the corresponding challenge and response, by means of which the robustness of the bit string extraction process can be improved. For example, the response reliability information may consist of pointers to reliable portions of the response in its analog or digitized form, i.e. those portions that are unlikely to be affected by noise. During authentication, the response reliability information is used to select certain portions of the physical output as ingredients for the bit string extraction process, or to give more weight to some portions than to others, or to disregard non-reliable portions.

It is also possible to combine the response reliability information and error-correcting code methods.

A drawback of the response reliability information method is that the assignment of the predicate “reliability” only reflects the enrolment phase. At that moment, the properties of the noise that will occur during authentication are not known. In many applications, the response data is obtained on a different testing station during enrolment than during authentication. Each testing station has its own particular perturbations and misalignments. Furthermore, in many applications of tokens, such as smart cards, there is a multitude of testing stations to choose from during authentication, so that it is impossible to anticipate the characteristics of a testing station that the user is going to use. Finally, also the environmental effects as mentioned above give rise to noise, and therefore the reliability of the data may change from measurement to measurement, even on the same testing station. Hence, there is still a substantial probability that bits which are labeled as reliable during enrolment actually get flipped during authentication, resulting in a failure to generate a common shared secret between the two parties.

It is therefore an object of the invention to provide a more robust method of generating a shared secret between two parties.

It is a further object of the invention to provide a more robust system for generating such a shared secret, comprising a proving apparatus and a verifying apparatus, and to provide the proving apparatus and the verifying apparatus.

According to the invention, the first object is achieved by a method as defined in claim 1.

In this method, the prover-specific response reliability information is used in combination with the verifier-specific response reliability information in order to generate the shared secret from the prover-specific response and/or from the verifier-specific response, resulting in the fact that the probability of inconsistently generating the shared secret, i.e. failing to generate the shared secret, is significantly reduced.

In other words, according to the invention, a two-way use of helper data is adopted.

In an embodiment of the method according to the invention, both parties have access to the prover-specific response reliability information and the verifier-specific response reliability information, and both parties generate the shared secret. In an alternative embodiment, only one party has access to the prover-specific response, the prover-specific response reliability information and the verifier-specific response reliability information, and is therefore able to generate the shared secret. In this case, the party that generated the shared secret transmits shared secret-related information to the other party, so that also the other party can determine the shared secret.

The shared secret-related information may be a pointer to a portion of the response, marked as reliable by both the prover-specific response reliability information and the verifier-specific response reliability information upon which the key is generated.

The invention has the following advantages:
from the same physical measurement, it is possible to reliably construct a longer identifying string than in the prior art, providing a larger range of identification numbers;
from the same physical measurement, it is possible to construct a longer cryptographic key than in the prior art, improving the security;
it is possible to keep the same key length as in the prior art, but now with improved noise tolerance;
the improved noise tolerance allows a cost reduction for the token and the measurement apparatus.

In an embodiment of the invention, the size of the shared secret may be flexible. After the two helper data have been combined, it may happen that the size of the shared secret is substantially different than was foreseen. The two parties can then negotiate the size of the key that is going to be used and together decide on a certain key length other than a preordained one. The owner of the smart card containing the physical token may even be involved, e.g. he is asked whether he can accept a somewhat shorter session key.

Furthermore, the error-correcting codes, if used, are less complex and yield a robust, yet simple scheme for error correction.

As the expected number of errors in the derivation of the bit string is reduced due to the invention, the computational effort of error correction by means of an error-correcting code is further reduced and has a more than linear computational advantage. Thus, the combination of the two-way helper data invention with an error-correcting code yields an advantage which is bigger than just the sum of the parts.

As a simple example of the difference in error probabilities, the measurements on a single, Gaussian-distributed variable with standard deviation σ can be considered. If the first measurement (enrolment) yields a value f, with an absolute value which is larger than some threshold T, the variable is deemed “robust”. Given such a robust variable, the probability that a bit flip will occur in the second measurement, according to the prior art method (one-way helper data), is equal to the probability that the second measurement yields a number F with a sign opposite from f. This probability is

ErrorProb(one-way)=½[1-Erf(f/2σ)].

However, if the two-way helper data method according to the invention is used, the probability of a bit flip is equal to the probability that F does not only have an opposite sign, but also an absolute value which is larger than the threshold T,

ErrorProb(two-way)=½[1-Erf((f+T)/2σ)].

It is logical to choose the threshold T to be larger than σ, as in the following examples. For T=1.5×σ and f just above the threshold, the one-way method has a bit error probability of 14%, whereas the two-way method has a bit error probability of only 2%. For T=2×σ, the percentages are 8% versus 0.2%. In both cases, the present invention results in a drastic reduction of the error probability.

Finally, the communication channel between the prover and the verifier is assumed to be a public channel. All information which is exchanged according to the invention can be sent back and forth on open public channels without any risk, as the amount and kind of information is insufficient for a third party to reveal any secrets or generate a copy of the secret bit string. Moreover, the amount of information revealed to the public (at most: the type of challenge along with the two sets of helper data) is just enough to let the two parties decide on a joint secret.

In different embodiments, the shared secret is to be used for either identification, for authorization or secure communication between said two parties.

The invention further relates to computer-readable media having instructions stored therein for causing processing units in a proving party and in a verifying party, respectively, to execute the methods above.

Various embodiments of the method according to the invention are defined in the dependent claims

According to the invention, the further object is achieved by a system as defined in claim 13, a proving apparatus as defined in claim 14 and a verifying apparatus as defined in claim 15.

The selection means may be located in either the proving apparatus or the verifying apparatus, or in a third party.

Independently of the selection means, the response reliability calculation means may be located in the proving apparatus or in a third party.

Independently of the selection means and the response reliability calculation means, the shared secret calculation means may be located in any one or both of the proving apparatus and the verifying apparatus, or in a third party. In an embodiment, the response reliability calculation means and the shared secret calculation means are integral, as part of the proving apparatus, or located in a third party.

Preferred embodiments of the invention will now be described with reference to the drawings, in which

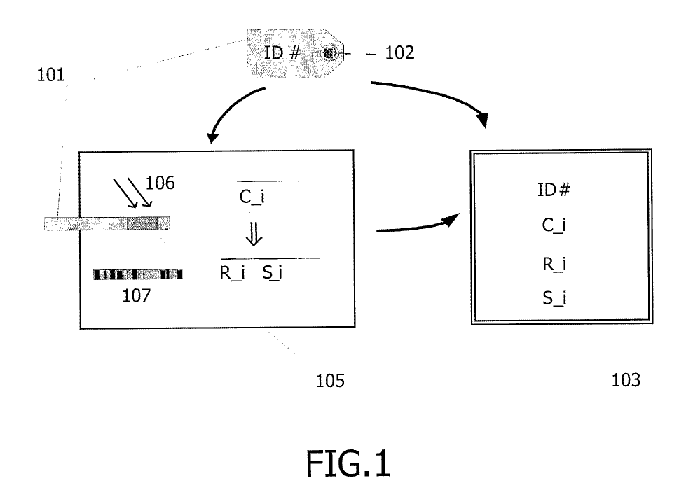

FIG. 1 illustrates the enrolment or bootstrapping phase for a PUF-card,

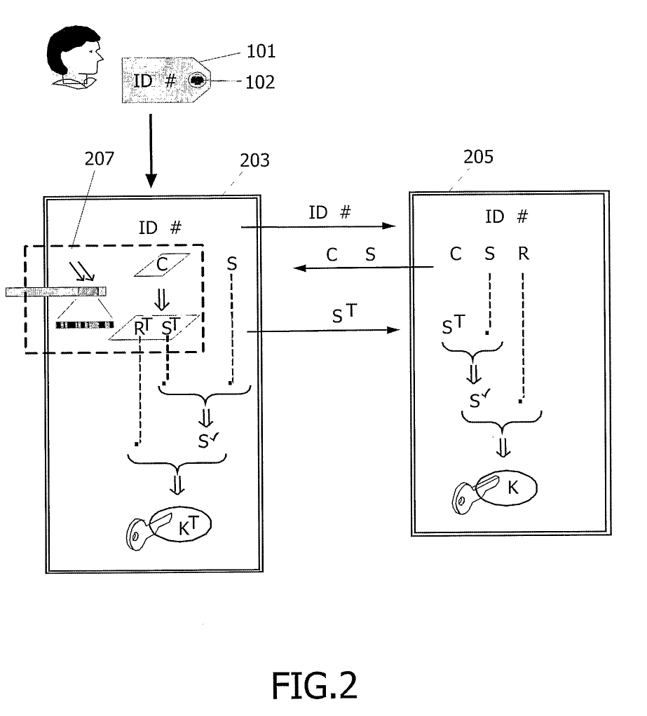

FIG. 2 shows the challenging of a PUF, the flow of information, and the session key generation during use of a PUF-card, based on a two-way error correction scheme according to the invention.

FIG. 1 illustrates the enrolment or bootstrapping phase of a physical token according to the invention. A physical token, 102, along with an identification tag, referred to as ID # in the Figure, is inserted in a testing apparatus 105 and subjected to a series of challenges C_i, wherein the subscript i refers to the challenge number. In one embodiment of the invention, the physical token is embedded in a smart card 101. As an example, the physical token may consist of a PUF, e.g. a 3D inhomogeneous medium with irreproducible scatterers in it. The challenge is an incident beam 106 identified by means of some parameters, e.g. angle of incidence, wavelength, etc.

Theoretically, a physical token can be challenged in a very large number of ways. However, in practice, the number of challenges a physical token is subjected to during enrolment is rather of the order of e.g. several hundreds for mainly two reasons, namely, first, to reduce the time spent on the physical measurements and, secondly, to keep the storage requirements at a reasonably low level. Therefore, only as many challenges as needed are made. Furthermore, the data on the smart card can always be renewed and a new set of challenges can be made on the physical token.

For each challenge C_i with which the physical token is challenged, the corresponding response R_i is detected and enrolment-specific side information S_i, also called helper data response reliability information, is derived. The enrolment-specific helper data S_i contains information about data that is reliable and data that is not reliable. The response and the helper data are specific for the testing station used. In the example with the testing being an illumination of a PUF, the response could then be a 2D speckle pattern filtered into a bit string, where each bit represents the light intensity at a specific location. The helper data then consists of a set of pointers to bits in the response containing reliable data, e.g. to bits corresponding to locations where the light intensity is either definitely low or definitely high. The helper data may also take the form of a mask of the response, i.e. an array of bits having the same number of bits as the bit string that represents the response, wherein a “1” indicates that the corresponding bit in the response is reliable, and a “0” indicates that it is not reliable.

Finally, the identity ID # of the physical token, the challenges C_i, the corresponding detected responses R_i, and side information S_i, all of which jointly form the enrolment data, are stored in a database server 103, where they are accessible by a verifying apparatus during a subsequent authentication phase. The data are stored in such a way that the challenges and the corresponding responses and helper data are linked to the identity ID # of the physical token, so that these data can later be pulled out from information on the token's identity alone.

In some applications, it is also possible that a central database does not exist. The challenge-response data may also be totally or partially stored on the smart card, in an encrypted form, if necessary. Alternatively, the challenge and response data is spread across many different data carriers.

FIG. 2 shows how a mutual and secret key K is obtained by two parties, with a proving apparatus 203 and a verifying apparatus 205 according to one embodiment of the invention, using a two-way error correction scheme. A smart card, 101, containing identification information, ID #, and a physical token 102 is used in a proving apparatus 203, or terminal. The ID # is sent to a verifying apparatus 205, for example, a central database server containing, or having direct access to, all stored measurements in the enrolment phase of the physical token, that is, the enrolment data. The ID # is linked to these measurements, from which one of the stored challenges C is chosen and sent back to the terminal on open public communication channels along with its corresponding server-specific side information S. At the terminal, the challenge C is performed on the physical token 102 in a measuring/testing station 207, indicated by the hatched line in FIG. 2, and the corresponding terminal-specific response R^{T} and terminal-specific side information S^{T} is obtained. In general, the measuring station, 207, will be a station which is different from the one used in the bootstrapping phase in FIG. 1. The terminal-specific side information S^{T} may be obtained by using the same procedure for helper data extraction that was employed during enrolment, but it may also be a different procedure. Due to noise in the physical measurements, along with possible inaccuracies in the testing apparatus, the response R^{T} is probably not the same as was measured initially in the enrolment phase, R. The terminal-specific side information S^{T} concerning the response R^{T} generated during use by the terminal 203 is sent back to the database server 205. In both systems, the terminal 203 and the database server 205, the two sets of helper data, server-specific S and terminal-specific S^{T}, are combined, which yields combined helper data S^{v} common to both systems. Finally, both parties use a common procedure to generate a secret key. The server generates K from R and S^{v}. The terminal generates K^{T} from R^{T} and S^{v}. With a very high probability, K and K^{T} are identical because they are now based on those portions of the physical output that have been found to be reliable by both parties.

In one embodiment of the invention, the key length may be flexible. When both parties know S^{v}, they can jointly decide to choose a certain key length other than a preordained one. After use, the key K is discarded and the challenge C is never used again on this specific physical token.

The use of the two-way helper data as described above may be combined with an error-correcting code of some sort to reduce the probability of bit errors in the shared secret even further.

In a broader sense, the invention does not only cover a terminal and a database server, but more generally a proving party with a physical token and a verifying party.

As also mentioned with reference to FIG. 1, it is possible according to the invention that the enrolment data is situated anywhere at all, e.g. on the smart card right next to the token (in an encrypted form, if necessary), or spread across different storage media (e.g. accessible online via the Internet). One viable option is to have just the terminal and the smart card, without needing the central server. The challenges can be stored anywhere as well, so that the verifier might not have them. According to the invention, the verifier does not have to know everything about the challenges.

Furthermore, the proving party or terminal does not have to send the new terminal-specific helper data in its literal form; he may e.g. send S^{v} or any function of S^{T} that allows the verifier to derive S^{T} or S^{v}.

According to the invention, it is also possible that the terminal or proving party has few computational resources. In this case, it can send more or less raw response data to the server, so that the server computes the second set of helper data and then tells the terminal about the result of S^{T} or S^{v}. All of this can be done in a secure way if the proper encryptions are employed.

In the case mentioned above, the invention may involve preprocessing of the raw data so that the data sent to the server has a manageable size.

In yet another embodiment of the invention, the extraction of the helper data during authentication may depend on the helper data from enrolment. This may be any kind of functional dependence.

In a further embodiment of the invention, threshold values that were used for generating the verifier-specific helper data may be accessed by the proving party to help with the extraction of the prover-specific helper data.

It should be noted that the above-mentioned embodiments illustrate rather than limit the invention, and that those skilled in the art will be able to design many alternative embodiments without departing from the scope of the appended claims. In the claims, any reference sign placed between parentheses shall not be construed as limiting the claim. Use of the verb ‘comprise’ and its conjugations does not exclude the presence of elements or steps other than those stated in a claim. Use of the article “a” or “an” preceding an element or step does not exclude the presence of a plurality of such elements or steps. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of generating a shared secret based on a physical token between a proving party and a verifying party, which physical token produces a response when challenged with a challenge, the verifying party having access to enrolment data comprising one or more challenges for challenging the physical token, and, for each challenge of the one or more challenges, a verifier-specific response and verifier-specific response reliability information, the method comprising the steps of:
selecting a challenge from the one or more challenges, and transmitting the selected challenge, so that both the proving party and the verifying party have access to the selected challenge;
challenging the physical token with the selected challenge so as to obtain a prover-specific response, and deriving prover-specific response reliability information from the prover-specific response obtained;
transmitting information to the proving party and/or to the verifying party, so that at least one of the proving party and the verifying party can access both the prover-specific response reliability information and the verifier-specific response reliability information;
generating the shared secret in the at least one of the proving party and the verifying party, based on the prover-specific response reliability information, the verifier-specific response reliability information, and the prover-specific response or the verifier-specific response.

2. A method as claimed in claim 1, further comprising the step of transmitting shared secret-related information between the proving party and the verifying party, so that any one of the proving party and the verifying party can determine the shared secret.

3. A method as claimed in claim 1, wherein the step of transmitting information comprises transmitting the prover-specific helper data from the proving party to the verifying party, and wherein the shared secret is generated in the verifying party.

4. A method as claimed in claim 1, wherein the step of transmitting information comprises transmitting the verifier-specific helper data from the verifying party to the proving party, and wherein the shared secret is generated in the proving party.

5. A method as claimed in claim 1, wherein the step of deriving prover-specific response reliability information from the prover-specific response obtained is outsourced to an auxiliary device.

6. A method as claimed in claim 1, wherein the enrolment data comprise encrypted enrolment data and the method further comprises the step of decrypting the encrypted enrolment data.

7. A method as claimed in claim 6, wherein the step of decrypting the encrypted enrolment data is outsourced to a third party.

8. A method as claimed in claim 1, wherein the shared secret is to be used for authentication between the proving party and the verifying party.

9. A method as claimed in claim 1, wherein the shared secret is to be used for identification.

10. A method as claimed in claim 1, wherein the shared secret is to be used for secure communication between the proving party and the verifying party.

11. A method as claimed in claim 1, wherein the physical token is a PUF.

12. A method as claimed in claim 1, wherein the physical token is an optical identifier and the challenge is an incident beam of light.

13. A system for generating a shared secret based on a physical token, comprising two apparatuses, a proving apparatus and a verifying apparatus, connected to each other by transmission means, the physical token producing a response when challenged with a challenge, the verifying apparatus having access to enrolment data comprising one or more challenges, and, for each challenge of the one or more challenges, a verifier-specific response and verifier-specific response reliability information, the system comprising:
selection means for selecting a challenge from the one or more challenges, and units for transmitting the selected challenge, so that both the proving party and the verifying party have access to the selected challenge,
challenging means and detection means, in the proving apparatus, for challenging the physical token with the selected challenge so as to obtain a prover-specific response, and for detecting the prover-specific response, respectively,
response reliability calculation means for deriving prover-specific response reliability information from the prover-specific response obtained,
one or more units for transmitting information between the two apparatuses, so that at least one of the two apparatuses can access both the prover-specific response reliability information and the verifier-specific response reliability information, and
shared secret calculation means for generating the shared secret, based on the prover-specific response reliability information, the verifier-specific response reliability information, and the prover-specific response or the verifier-specific response.

14. A proving apparatus for use in a system for generating a shared secret based on a physical token, which physical token produces a response when challenged with a challenge, the system comprising, besides the proving apparatus, a verifying apparatus connected to the proving apparatus by transmission means, comprising:
selection means for selecting a challenge from one or more challenges, or a unit for receiving a selected challenge,
challenging means and detection means for challenging the physical token with the selected challenge so as to obtain a prover-specific response, and for detecting the prover-specific response, respectively,
response reliability calculation means for deriving prover-specific response reliability information from the prover-specific response obtained,
a unit for receiving, from the verifying apparatus, verifier-specific response reliability information corresponding to the selected challenge, and
shared secret calculation means for generating the shared secret, based on the prover-specific response, the prover-specific response reliability information and the verifier-specific response reliability information.

15. A verifying apparatus for use in a system for generating a shared secret based on a physical token, which physical token produces a response when challenged with a challenge, the system comprising, besides the verifying apparatus, a proving apparatus connected to the verifying apparatus by transmission means, comprising:
selection means for selecting a challenge from one or more challenges, or a unit for receiving a selected challenge,
means for accessing enrolment data comprising the one or more challenges, and, for each challenge of the one or more challenges, a verifier-specific response and verifier-specific response reliability information,
a unit for receiving, from the proving apparatus, prover-specific response reliability information corresponding to the selected challenge, and
shared secret calculation means for generating the shared secret, based on the verifier-specific response corresponding to the selected challenge, the prover-specific response reliability information and the verifier-specific response reliability information.
